(19) United States
(12) Patent Application Publication
(10) Pub. No.: US 2023/0299536 A1
(43) Pub. Date: Sep. 21, 2023

(54) JOINT CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Nungna WI, Mie (JP); Shinji NOZAKI, Mie (JP); Yasunori ASANO, Mie (JP); Daisuke SAITO, Mie (JP)

(21) Appl. No.: 18/021,515

(22) PCT Filed: Jul. 29, 2021
(86) PCT No.: PCT/JP2021/028216

§ 371 Date: Feb. 15, 2023

(30) Foreign Application Priority Data
Aug. 31, 2020 (JP) 2020-145163

(51) Int. Cl. H01R 13/514; H01R 31/08

(52) U.S. Cl. CPC H01R 13/514; H01R 31/08

(57) ABSTRACT

It is aimed to suppress a cost increase even if short-circuit patterns increase. A joint connector is provided with a male terminal fitting including a plurality of tabs arranged in parallel in a first arrangement direction and a male carrier coupling the plurality of tabs in parallel and cuttable between arbitrary adjacent ones of the tabs, and a female terminal fitting including a plurality of female connecting portions arranged in parallel in a second arrangement direction orthogonal to the first arrangement direction and a female carrier coupling the plurality of female connecting portions in parallel and cuttable between arbitrary adjacent ones of the female connecting portions. A plurality of male terminal fittings is arranged in parallel to the second arrangement direction. A plurality of female terminal fittings is arranged in parallel to the first arrangement direction with the plurality of female connecting portions connected to the plurality of tabs.

### TECHNICAL FIELD

The present disclosure relates to a joint connector.

### BACKGROUND

Patent Document 1 discloses a joint connector structured such that a plurality of male terminals are arranged to stand in a matrix manner on a printed circuit board and desired male terminals are shorted to each other by a circuit pattern formed on the printed circuit board.

### PRIOR ART DOCUMENT

### Patent Document

Patent Document 1: JP 2004-111279 A

### SUMMARY OF THE INVENTION

### Problem to be Solved

For this joint connector, a printed circuit board having the same circuit pattern as a short-circuit pattern needs to be prepared for each different short-circuit pattern of the male terminals. That is, if the number of types of the short-circuit patterns of the male terminals increases, the number of types of the printed circuit boards increases accordingly. The printed circuit board is a relatively expensive component. Thus, as the short-circuit patterns increase, cost increases since the number of types of necessary printed circuit boards also increases.

A joint connector of the present disclosure was completed on the basis of the above situation and aims to suppress a cost increase even if short-circuit patterns increase.

### Means to Solve the Problem

The present disclosure is directed to a joint connector with a male terminal fitting including a plurality of tabs arranged in parallel in a first arrangement direction and a male carrier coupling the plurality of tabs in parallel, the male carrier being cuttable between arbitrary adjacent ones of the tabs, and a female terminal fitting including a plurality of female connecting portions arranged in parallel in a second arrangement direction orthogonal to the first arrangement direction and a female carrier coupling the plurality of female connecting portions in parallel, the female carrier being cuttable between arbitrary adjacent ones of the female connecting portions, a plurality of the male terminal fittings being arranged in parallel to the second arrangement direction, and a plurality of the female terminal fittings being arranged in parallel to the first arrangement direction with a plurality of the female connecting portions connected to a plurality of the tabs.

### Effect of the Invention

According to the present disclosure, it is possible to suppress a cost increase even if short-circuit patterns increase.

### BRIEF DESCRIPTION OF THE DRAWINGS

FIG. 1 is a front view in section showing a state where a male housing and a female housing are assembled without cutting male carriers and female carriers.

FIG. 2 is a front view in section showing a state where the male and female housings are assembled with the male and female carriers cut.

FIG. 3 is a side view in section showing a state where the male and female housings are assembled.

FIG. 4 is a plan view in section showing a state where the male and female housings are assembled.

FIG. 5 is a perspective view of a male terminal fitting.

FIG. 6 is a perspective view of a female connector in an assembled state.

FIG. 7 is a perspective view of a female terminal fitting.

FIG. 8 is a perspective view showing the female housing in an disassembled state.

### DETAILED DESCRIPTION TO EXECUTE THE INVENTION

[Description of Embodiments of Present Disclosure]

First, embodiments of the present disclosure are listed and described.

(1) The joint connector of the present disclosure is provided with a male terminal fitting including a plurality of tabs arranged in parallel in a first arrangement direction and a male carrier coupling the plurality of tabs in parallel, the male carrier being cuttable between arbitrary adjacent ones of the tabs, and a female terminal fitting including a plurality of female connecting portions arranged in parallel in a second arrangement direction orthogonal to the first arrangement direction and a female carrier coupling the plurality of female connecting portions in parallel, the female carrier being cuttable between arbitrary adjacent ones of the female connecting portions, a plurality of the male terminal fittings being arranged in parallel to the second arrangement direction, and a plurality of the female terminal fittings being arranged in parallel to the first arrangement direction with a plurality of the female connecting portions connected to a plurality of the tabs. According to the configuration of the present disclosure, a desired short-circuit pattern can be obtained by cutting either the male carriers or the female carriers or the both carriers. Even if the number of types of the short-circuit patterns increases, the number of types of components is not increased since the male terminal fittings and the female terminal fittings can be commonly used. Therefore, according to the present disclosure, a cost increase can be suppressed even if the short-circuit patterns increase.

(2) Preferably, the joint connector is provided with a male housing for holding the plurality of male terminal fittings in parallel in the second arrangement direction, and a female housing for holding the plurality of female terminal fittings in parallel in the first arrangement direction. According to this configuration, the plurality of tabs and the plurality of female connecting portions can be connected by a one-action operation of assembling the male housing and the female housing.

(3) Preferably, in (2), the female housing includes a flat-shaped housing constituent for holding the female terminal fitting, and a plurality of the housing constituents are stacked in the first arrangement direction. According to this configuration, since the housing constituents and the female terminal fittings can be commonly used for a plurality of types of the male terminal fittings having different numbers of the tabs, the numbers of types of the female housings and the female terminal fittings can be reduced.

(4) Preferably, in (3), the housing constituents adjacent in a stacking direction are formed with locking portions for holding the housing constituents in a mutually stacked state by being locked to each other, and the locking portions are arranged point-symmetrically on a virtual plane parallel to both the first arrangement direction and the second arrangement direction. According to this configuration, since the housing constituents can be stacked even in an inverted state, workability in assembling the housing constituents with each other is good.

(5) Preferably, the female connecting portions are formed by bending a metal plate material, and the female carrier is bent to bring the female connecting portions adjacent in the second arrangement direction closer. Since the female connecting portions formed by bending the metal plate material have a large area in a developed state, there is a concern that the female carrier coupling the female connecting portions adjacent in the second arrangement direction becomes long. However, since intervals between the female connecting portions adjacent in the second arrangement direction can be narrowed by bending the female carrier, a size reduction can be achieved.

[Details of Embodiment of Present Disclosure]

### Embodiment

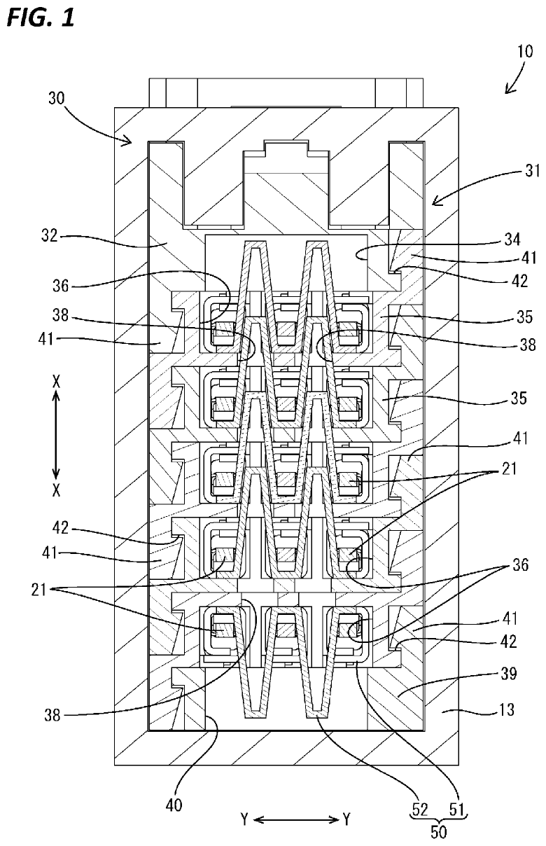

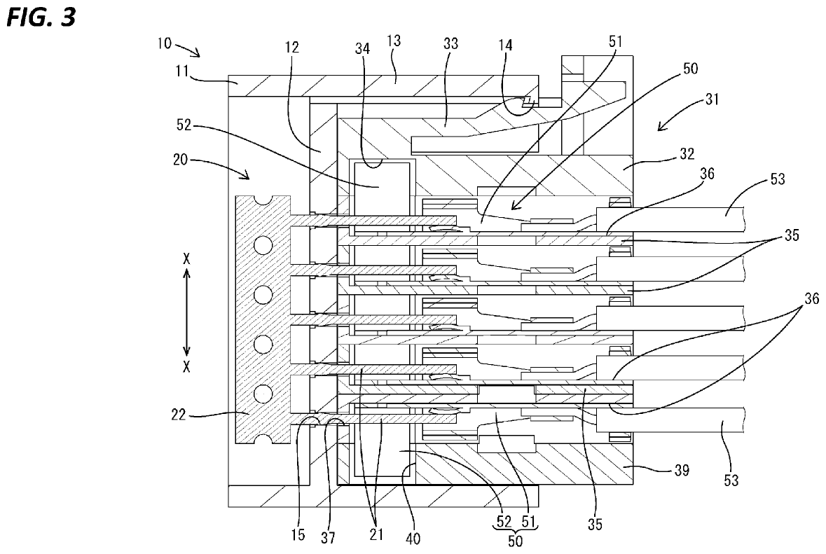

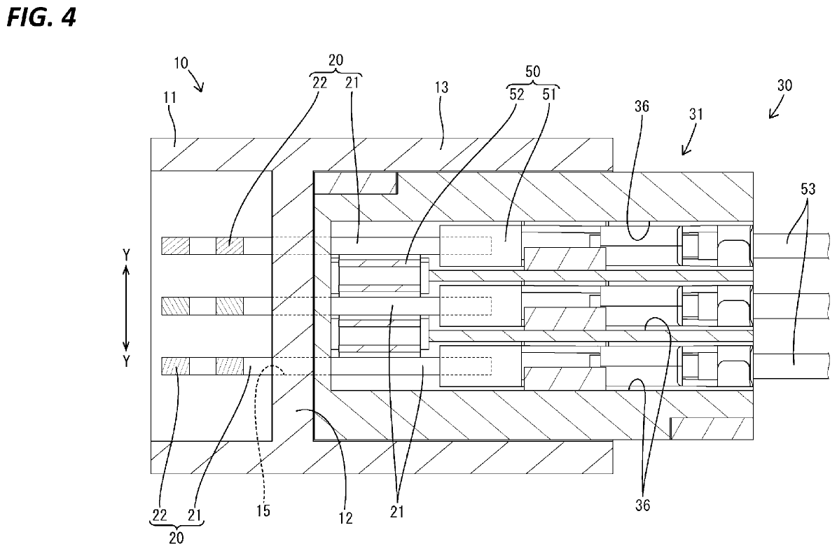

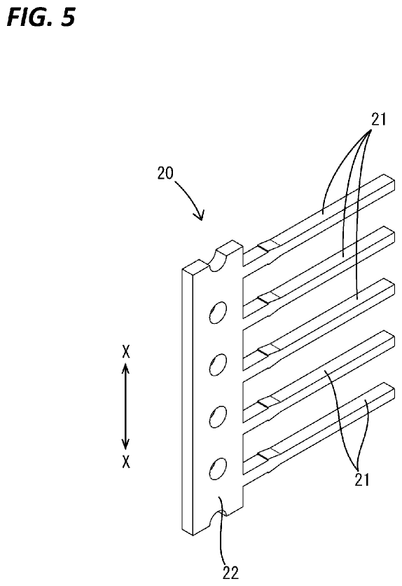

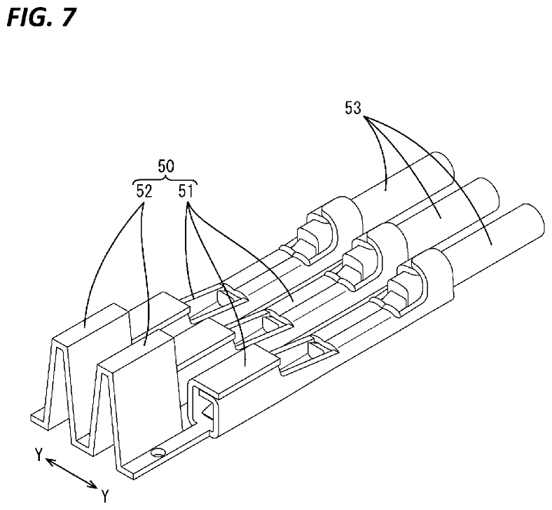

A specific embodiment of a joint connector of the present disclosure is described below with reference to FIGS. 1 to 8. Note that the present invention is not limited to these illustrations, but is represented by claims and intended to include all changes in the scope of claims and in the meaning and scope of equivalents. In this embodiment, a left side in FIGS. 3 and 4 and an oblique left lower side in FIGS. 5 to 8 are defined as a front side concerning a front-rear direction. Upper and lower sides shown in FIGS. 1 to 3 and 5 to 8 are directly defined as upper and lower sides concerning a vertical direction. Left and right sides shown in FIGS. 1, 2 and 4 are directly defined as left and right sides concerning a lateral direction.

A joint connector of this embodiment is provided with one male connector 10 and a plurality of (three in this embodiment) female connectors 30. The male connector 10 is provided with a male housing 11 made of synthetic resin and a plurality of male terminal fittings 20. As shown in FIGS. 3 and 4, the male housing 11 includes a flat plate-like terminal holding portion 12 and a receptacle 13 in the form of a rectangular tube projecting rearward from the outer peripheral edge of the terminal holding portion 12. The terminal holding portion 12 is formed with a plurality of (fifteen in this embodiment) press-fit holes 15 penetrating through the terminal holding portion 12 in the front-rear direction. The receptacle 13 is formed with a projection-like lock portion 14.

The plurality of press-fit holes 15 are arranged to be aligned in a first arrangement direction X (vertical direction) and a second arrangement direction Y (lateral direction). That is, the plurality of press-fit holes 15 are separated in five stages in the first arrangement direction X, and separated in three rows in the second arrangement direction Y. In each stage, three press-fit holes 15 are linearly arranged along the second arrangement direction Y. In each row, five press-fit holes 15 are linearly arranged along the first arrangement direction X.

The male terminal fitting 20 is constituted by a metal plate material stamped into a predetermined shape by press working. As shown in FIG. 5, one male terminal fitting 20 is a single component including a plurality of (five in this embodiment) elongated tabs 21 and one male carrier 22. The five tabs 21 are arranged at certain intervals in parallel to the first arrangement direction X with length directions oriented in the front-rear direction (direction orthogonal to both the first and second arrangement directions X, Y). The male carrier 22 has a shape elongated in a direction parallel to the first arrangement direction X and couples front end parts of the five tabs 21 to each other. The male carrier 22 can be cut between arbitrary adjacent ones of the tabs 21.

Each male terminal fitting 20 is so mounted into the male housing 11 that the five tabs 21 are arranged in parallel to the first arrangement direction X. In mounting the male terminal fitting 20, the five tabs 21 are individually press-fit into five press-fit holes 15 from the front of the male housing 11. Since the plurality of press-fit holes 15 are aligned separately in three rows in the lateral direction, three male terminal fittings 20 are mounted in the male housing 11 while being arranged in parallel in the second arrangement direction Y.

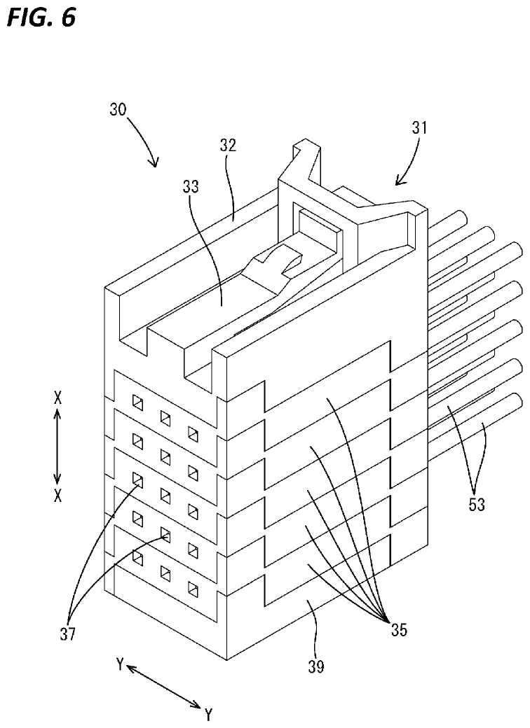

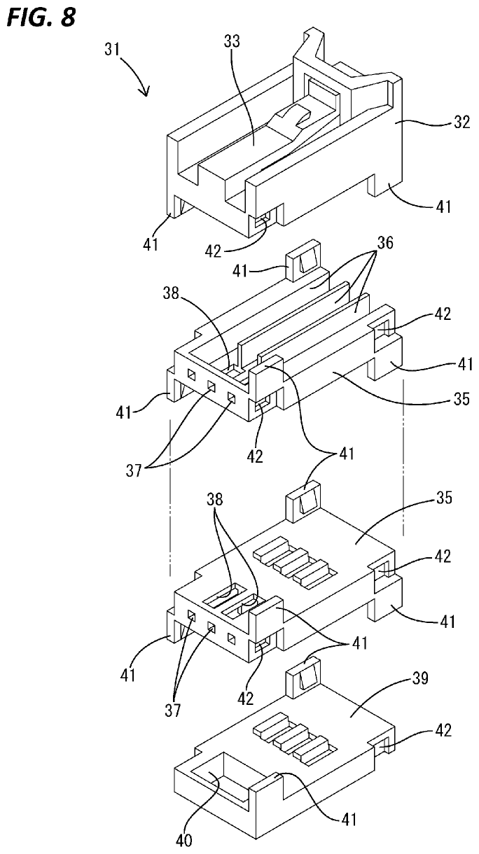

The female connector 30 includes one female housing 31 made of synthetic resin and a plurality of (five in this embodiment) female terminal fittings 50. As shown in FIGS. 6 and 8, the female housing 31 is configured by assembling one upper housing 32, as many (five in this embodiment) housing constituents 35 as the female terminal fittings 50, and one lower housing 39. Any of the upper housing 32, the housing constituents 35 and the lower housing 39 has a flat shape having a dimension in the vertical direction smaller than those in the front-rear direction and lateral direction. By successively assembling the upper housing 32, the five housing constituents 35 and the lower housing 39 in a stacked state from above, the female housing 31 is configured.

A lock arm 33 is formed on the upper surface of the upper housing 32. As shown in FIGS. 1 and 3, an upper accommodation recess 34 is formed in the lower surface of the upper housing 32. In a front view of the upper housing 32 (female housing 31), a locking projection 41 projecting downward is formed on the left side surface of a front end part of the upper housing 32, and a locking recess 42 is formed in the right side surface of the front end part of the upper housing 32. In the front view, a locking recess 42 is formed in the left side surface of a rear end part of the upper housing 32 and a locking projection 41 projecting downward is formed on the right side surface of the rear end part of the upper housing 32.

Terminal accommodation chambers 36 are formed in the housing constituent 35. The terminal accommodation chambers 36 are open in the upper surface of the housing constituent 35. Three insertion openings 37 penetrating from the front surface of the housing constituent 35 to the terminal accommodation chambers 36 are formed side by side in parallel to the second arrangement direction Y in a front surface wall of the housing constituent 35. A pair of left and right communication holes 38 extending from the terminal accommodation chambers 36 to the lower surface of the housing constituent 35 are formed in a front end part of a bottom wall part of the housing constituent 35.

In a front view of the housing constituent 35 (female housing 31), a locking recess 42 and a locking projection 41 projecting downward are formed on the left side surface of a front end part of the housing constituent 35. In the front view, a locking recess 42 and a locking projection 41 projecting upward are formed on the right side surface of the front end part of the housing constituent 35. The both left and right locking projections 41 of the front end part of the housing constituent 35 are positioned point-symmetrically in the front view, and the both left and right locking recesses 42 of the front end part of the housing constituent 35 are also positioned point-symmetrically in the front view.

In the front view, a locking recess 42 and a locking projection 41 projecting upward are formed on the left side surface of a rear end part of the housing constituent 35. In the front view, a locking recess 42 and a locking projection 41 projecting downward are formed on the right side surface of the rear end part of the housing constituent 35. The both left and right locking projections 41 of the rear end part of the housing constituent 35 are positioned point-symmetrically in the front view, and the both left and right locking recesses 42 of the rear end part of the housing constituent 35 are also positioned point-symmetrically in the front view.

A lower accommodation recess 40 penetrating through the lower housing 39 in the vertical direction is formed in a front end part of the lower housing 39. In a front view of the lower housing 39 (female housing 31), a locking projection 41 projecting upward is formed on the right side surface of a front end part of the lower housing 39, and a locking recess 42 is formed in the left side surface of the front end part of the lower housing 39. In the front view, a locking recess 42 is formed in the right side surface of a rear end part of the lower housing 39, and a locking projection 41 projecting upward is formed on the left side surface of the rear end part of the lower housing 39.

The female terminal fitting 50 is formed by bending a metal plate material stamped into a predetermined shape by press working. One female terminal fitting 50 is a single component including a plurality of (three in this embodiment) female connecting portions 51 and one female carrier 52. The three female connecting portions 51 are arranged at certain intervals in parallel to the second arrangement direction Y with length directions oriented in the front-rear direction (direction orthogonal to both the first and second arrangement directions X, Y). A wire 53 is connected to a rear end part of each female connecting portion 51.

The female carrier 52 is formed by bending a flat plate-like part elongated in a direction parallel to the second arrangement direction Y and couples front end parts of the three female connecting portions 51. In a front view, the female carrier 52 is bent into a chevron shape (inverted V shape). By forming the female carrier 52 into a chevron shape by bending, intervals between the adjacent female connecting portions 51 coupled by the female carrier 52 are narrower as compared to the case where the female carrier 52 is in the form of a flat plate without being bent. The female carrier 52 can be cut between arbitrary adjacent ones of the female connecting portions 51.

Each female terminal fitting 50 is so mounted into the female housing 31 that the three female connecting portions 51 are arranged in parallel to the second arrangement direction Y. One female terminal fitting 50 is mounted in one housing constituent 35. With the female terminal fitting 50 mounted in the housing constituent 35, the female connecting portions 51 are accommodated in the terminal accommodation chambers 36 and the respective female connecting portions 51 and the insertion openings 37 are positioned to face each other in the front-rear direction. The female carrier 52 projects further upward than the upper surface of the housing constituent 35 or project downward of the housing constituent 35 through the communication holes 38.

The five housing constituents 35 having the female terminal fittings 50 mounted therein are stacked in the vertical direction. The upper housing 32 is stacked on the upper surface of the housing constituent 35 in the upper most stage and the lower housing 39 is stacked on the lower surface of the housing constituent 35 in the lowermost stage. Any of the female carriers 52 of the female terminal fittings 50 mounted in the housing constituents 35 other than that in the lowermost stage projects upward, and upper end parts of the female carrier 52 in the lower stage are accommodated inside the female carrier 52 in the upper stage. The female carrier 52 of the female terminal fitting 50 mounted in the housing constituent 35 in the uppermost stage is accommodated into the upper accommodation recess 34 of the upper housing 32. The female carrier 52 of the female terminal fitting 50 mounted in the housing constituent 35 in the lowermost stage is accommodated into the lower accommodation recess 40 of the lower housing 39.

The housing constituents 35 stacked on each other are held in a stacked state by the locking of the locking projections 41 and the locking recesses 42. The upper housing 32 and the housing constituent 35 in the uppermost stage are also held in a stacked state by the locking of the locking projections 41 and the locking recesses 42. The housing constituent 35 in the lowermost stage and the lower housing 39 are also held in a stacked state by the locking of the locking projections 41 and the locking recesses 42.

In the above way, three female terminal fittings 50 are mounted in the female housing 31 at the same time as the female housing 31 is assembled. Each female terminal fitting 50 is so mounted in the female housing 31 that the three female connecting portions 51 are arranged in parallel to the second arrangement direction Y. Since the housing constituents 35 holding the respective female terminal fittings 50 are stacked in five stages in the vertical direction, the five female terminal fittings 50 are mounted in the female housing 31 while being arranged in parallel in the first arrangement direction X.

The male and female connectors 10, 30 are assembled by accommodating the female housing 31 into the receptacle 13. With the male and female connectors 10, 30 assembled, the lock arm 33 is locked to the lock portion 14 of the receptacle 13, whereby the male housing 11 and the female housing 31 are locked in a connected state. With the both connectors 10, 30 assembled, the respective tabs 21 are inserted in the female housing 31 through the insertion openings 37 and individually connected to the corresponding female connecting portions 51.

The joint connector of this embodiment can obtain an arbitrary short-circuit pattern by cutting some of the male and female carriers 22, 52. The male carriers 22 are cut before the male terminal fittings 20 are mounted into the male housing 11. The female carriers 52 are also cut before the female terminal fittings 50 are mounted into the female housing 31.

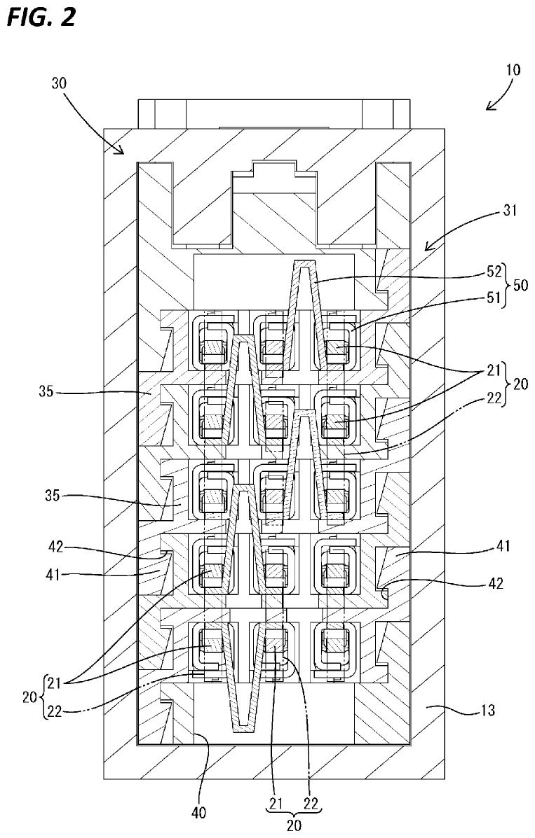

FIG. 2 shows an example of the short-circuit pattern. Since the male carrier 22 is not cut in the left male terminal fitting 20, five female connecting portions 51 on the left side connected to the tabs 21 of this left male terminal fitting 20 are shorted. Further, the left female connecting portions 51 and the center female connecting portions 51 are connected by the female carriers 52 in three female terminal fittings 50 mounted in the second, fourth and fifth housing constituents 35 from above, the center female connecting portions 51 in the lateral direction in the second, fourth and fifth stages from above are also shorted to the five female connecting portions 51 on the left side.

The joint connector of this embodiment includes the plurality of male terminal fittings 20 and the plurality of female terminal fittings 50. The male terminal fitting 20 includes the plurality of tabs 21 arranged in parallel in the first arrangement direction X and the male carrier 22 coupling the plurality of tabs 21 in parallel. The male carrier 22 can be cut between arbitrary adjacent ones of the tabs 21. The female terminal fitting 50 includes the plurality of female connecting portions 51 arranged in parallel in the second arrangement direction Y orthogonal to the first arrangement direction X and the female carrier 52 coupling the plurality of female connecting portions 51 in parallel. The female carrier 52 can be cut between arbitrary adjacent ones of the female connecting portions 51. The plurality of male terminal fittings 20 are arranged in parallel to the second arrangement direction Y. The plurality of female terminal fittings are arranged in parallel to the first arrangement direction X with the plurality of female connecting portions 51 connected to the plurality of tabs 21.

According to this configuration, a desired short-circuit pattern can be obtained by cutting either the male carriers 22 or the female carriers 52 or the both carriers. Even if the number of types of the short-circuit patterns increases, the number of types of components is not increased since the male terminal fittings 20 and the female terminal fittings 50 can be commonly used. Therefore, according to the joint connector of this embodiment, a cost increase can be suppressed even if the short-circuit patterns increase.

The joint connector includes the male housing 11 for holding the plurality of male terminal fittings 20 in parallel in the second arrangement direction Y. The joint connector 31 includes the female housing 31 for holding the plurality of female terminal fittings 50 in parallel in the first arrangement direction X. According to this configuration, the plurality of tabs 21 and the plurality of female connecting portions 51 can be connected by a one-action operation of assembling the male housing 11 and the female housing 31.

The female housing 31 includes the flat-shaped housing constituents 35 for holding the female terminal fittings 50. The plurality of housing constituents 35 are stacked in the first arrangement direction X. According to this configuration, since the housing constituents 35 and the female terminal fittings 50 can be commonly used for a plurality of types of the male terminal fittings 20 having different numbers of the tabs 21, the numbers of types of the female housings 31 and the female terminal fittings 50 can be reduced.

The housing constituents 35 adjacent in a stacking direction are formed with the locking projections 41 and the locking recesses 42 serving as locking portions for holding the housing constituents 35 in a mutually stacked state by being locked to each other. The locking projections 41 are arranged point-symmetrically on a virtual plane parallel to the first and second arrangement directions X, Y, i.e. in the front view of the female housing 31. According to this configuration, since the housing constituents 35 can be stacked even in an inverted state, workability in assembling the housing constituents 35 with each other is good.

The female connecting portions 51 are formed by bending the metal plate material. Since the female connecting portions 51 formed by bending the metal plate material have a large area in a developed state, there is a concern that the female carrier 52 coupling the female connecting portions 51 adjacent in the second arrangement direction Y becomes long and intervals between adjacent ones of the female connecting portions 51 increase. The female carrier 52 of the joint connector of this embodiment is bent to bring the female connecting portions 51 adjacent in the second arrangement direction Y closer. Therefore, a size reduction can be achieved by narrowing the intervals between the female connecting portions 51 adjacent in the second arrangement direction Y.

[Other Embodiments]

The present invention is not limited to the above described and illustrated embodiment, but is represented by claims. The present invention is intended to include all changes in the scope of claims and in the meaning and scope of equivalents and also include the following embodiments.

Although the plurality of male terminal fittings are held in the male housing and the plurality of female terminal fittings are held in the female housing in the above embodiment, a plurality of male terminal fittings and a plurality of female terminal fittings may be held in one housing.

Although the female housing is configured by stacking the plurality of housing constituents in the above embodiment, the female housing may be a single component.

Although the locking portions for holding the housing constituents in the mutually stacked state are point-symmetrical in the above embodiment, the locking portions may not be point-symmetrical.

Although the female carrier is bent into a V shape in the above embodiment, the female carrier may be bent into a U shape, an S shape, an N shape and the like.

### LIST OF REFERENCE SIGNS

10 . . . male connector
11 . . . male housing
12 . . . terminal holding portion
13 . . . receptacle
14 . . . lock portion
15 . . . press-fit hole
20 . . . male terminal fitting
21 . . . tab
22 . . . male carrier
30 . . . female connector
31 . . . female housing
32 . . . upper housing
33 . . . lock arm
34 . . . upper accommodation recess
35 . . . housing constituent
36 . . . terminal accommodation chamber
37 . . . insertion opening
38 . . . communication hole
39 . . . lower housing
40 . . . lower accommodation recess
41 . . . locking projection
42 . . . locking recess
50 . . . female terminal fitting
51 . . . female connecting portion
52 . . . female carrier
53 . . . wire
X . . . first arrangement direction
Y . . . second arrangement direction

1. A joint connector, comprising:
a male terminal fitting including a plurality of tabs arranged in parallel in a first arrangement direction and a male carrier coupling the plurality of tabs in parallel, the male carrier being cuttable between arbitrary adjacent ones of the tabs; and
a female terminal fitting including a plurality of female connecting portions arranged in parallel in a second arrangement direction orthogonal to the first arrangement direction and a female carrier coupling the plurality of female connecting portions in parallel, the female carrier being cuttable between arbitrary adjacent ones of the female connecting portions,
a plurality of the male terminal fittings being arranged in parallel to the second arrangement direction,
a plurality of the female terminal fittings being arranged in parallel to the first arrangement direction with a plurality of the female connecting portions connected to a plurality of the tabs,
the female terminal fitting being formed by bending a metal plate material,
the female carrier being bent into a chevron shape to bring the female connecting portions adjacent in the second arrangement direction closer, and
one female carrier being accommodated inside the other female carrier between the female carriers stacked in the first arrangement direction.

2. The joint connector of claim 1, comprising:
a male housing for holding the plurality of male terminal fittings in parallel in the second arrangement direction; and
a female housing for holding the plurality of female terminal fittings in parallel in the first arrangement direction.

3. The joint connector of claim 2, wherein:
the female housing includes a flat-shaped housing constituent for holding the female terminal fitting, and
a plurality of the housing constituents are stacked in the first arrangement direction.

4. The joint connector of claim 3, wherein:
the housing constituents adjacent in a stacking direction are formed with locking portions for holding the housing constituents in a mutually stacked state by being locked to each other, and
the locking portions are arranged point-symmetrically on a virtual plane parallel to both the first arrangement direction and the second arrangement direction.

5. (canceled)
